(19) United States
(12) Patent Application Publication
(10) Pub. No.: US 2019/0389319 A1
(43) Pub. Date: Dec. 26, 2019

(54) Receiving Device and Method for Production

(71) Applicant: Bombardier Primove GmbH, Berlin (DE)

(72) Inventors: Simon Wechsler, Hirschberg (DE); Roman Gunt, Heidelberg (DE)

(21) Appl. No.: 16/480,760

(22) PCT Filed: Jan. 24, 2018
(86) PCT No.: PCT/EP2018/051685

§ 371 Date: Jul. 25, 2019

(30) Foreign Application Priority Data
Jan. 26, 2017 (DE) 10 2017 101 583.3

(51) Int. Cl. B60L 53/12; F16J 15/48; G12B 9/02

(52) U.S. Cl. CPC B60L 53/12; G12B 9/02; F16J 15/48

(57) ABSTRACT

A receiving device for a system for inductive power transmission has a housing with a cover part and a base part as housing parts. The housing has an internal volume for receiving at least one winding structure. One of the housing parts has at least one rib and the other housing part has at least one groove for receiving the at least one rib. The at least one rib and the at least one groove are arranged between the internal volume and an external volume. The receiving device has at least one sealing element. At least one portion of the at least one rib and at least one portion of the at least one sealing element are arranged in at least one portion of the at least one groove. A method for producing the receiving device is also disclosed.

The invention relates to a receiving device for a system for inductive power transmission and to a method for producing such a receiving device. In particular, the invention relates to a receiving device for receiving an electromagnetic field and for providing electrical energy in an induction-based manner, in particular for use by a vehicle, further particularly by a car.

One application of the invention may lie in particular in the field of wireless energy transmission to vehicles, such as cars, buses, vans, lorries, forklift trucks and rail vehicles. The receiving device for this purpose can be configured in particular to provide electrical power in the region of several kilowatts, for example 20 kW.

During a journey on a roadway, a vehicle may require energy for its drive and the operation of auxiliary devices which are not used to drive the vehicle. Auxiliary devices can comprise, for example, a lighting system, heating system and/or an air-conditioning system, ventilation system and an information system. It is also known that not only rail-bound vehicles, such as trams, but also road vehicles can be operated with electrical energy.

Vehicles, in particular electric vehicles, can be supplied with electrical energy in various ways. One possibility is to charge a battery installed in the vehicle when the vehicle is stationary. For this purpose, a cable connection to the vehicle can be established. Another possibility is to transmit energy wirelessly to the vehicle, wherein an electromagnetic field is used, which induces an electrical voltage in at least one inductor in the vehicle. The term “receiving device” or “pick-up” may refer here to a device that comprises such an inductor.

The induction-based transmission of electrical energy to the vehicle forms the background of this invention. A conductor arrangement installed in the road, which can also be referred to as a primary winding structure, generates an electromagnetic field for power transmission. This field is received in the vehicle by a conductor arrangement which is arranged in the vehicle and which can also be referred to as a secondary winding structure or secondary coil, wherein the electromagnetic field generates an electrical voltage by induction. The energy transmitted in this way can be used to drive the vehicle and/or for other applications, for example for supplying auxiliary devices of the vehicle. The vehicle, for example, can be a vehicle having an electrically operable drive motor. However, the vehicle can also comprise a “hybrid” drive system, for example a system that can be operated with electrical energy or other energy, for example by the use of fuel, such as gas, diesel or petrol or hydrogen.

There is a need for integration of a receiving device with a secondary winding structure in existing vehicles, in particular cars. The weight of the receiving device should be low, such that it compromises the overall weight of the vehicle only to a minimal extent. Furthermore, the construction of the receiving device should be stable, and it should be easy to install the receiving device. Furthermore, existing installation spaces, in particular in the region of the underside of a vehicle, should be utilised.

Typically, the magnetic field (as part of an electromagnetic alternating field) is generated by a device that is arranged beneath the vehicle underside. Thus, a receiving device is typically installed on the underside of the vehicle, in order to receive the magnetic field from beneath. However, it is also possible to orient the receiving device in other directions, for example a horizontal direction, if the device for generating the electromagnetic field is arranged in the corresponding direction, for example on a wall. Generally, the receiving device has a receiving side, wherein during operation the magnetic field enters the receiving device from the receiving side.

WO 2014/166963 A1 discloses a receiving device for receiving a magnetic field and for providing electrical energy by magnetic induction, wherein the receiving device comprises at least one coil of an electrical line. Furthermore, the magnetic field induces an electrical voltage in the coil during operation. The coil furthermore comprises an inductor, wherein the receiving device and the coil are formed in such a way that a magnetic field can be received from a receiving side. The receiving device furthermore comprises a housing, which surrounds at least one coil and further components of the receiving device.

WO 2015/150297 A2 discloses a receiving device, in particular a receiving device for a system for inductive power transmission to a vehicle, wherein the receiving device comprises a housing. Furthermore, at least one medium is arranged in the housing, wherein the medium has a coefficient of thermal expansion that is smaller than the coefficient of thermal expansion of air.

In addition to a receiving winding structure (secondary winding structure), the receiving device can comprise further electrical and electronic components. For example, the receiving device can comprise a rectifier, wherein the rectifier can comprise power electronic elements. The receiving device may also comprise control elements and measurement elements.

In addition to the receiving winding structure, these further components can also be arranged in the housing of the receiving device. During operation of the vehicle with such a receiving device, great temperature changes can occur in respect of the temperature in the housing. In order to enable reliable operation of the receiving device, in particular of the electrical and electronic components, it is desirable to seal an internal volume of the housing reliably over the entire temperature range with respect to the infiltration of dirt and/or water.

The technical problem is that of creating a receiving device and a method for producing a receiving device for a system for inductive power transmission that enable reliable operation of the receiving device over a large temperature range.

The solution to the technical problem is provided by the subjects with the features of claims 1 and 12. Further advantageous embodiments of the invention are described in the dependent claims.

What is proposed is a receiving device for a system for inductive power transmission. The system can be used in particular for inductive power transmission to a vehicle, in particular a car. The receiving device comprises a housing, wherein the housing comprises a cover part and a base part as housing parts.

The housing can be installed on a vehicle. In particular, the housing can be installed on a vehicle frame, more particularly on a front axle carrier, of the vehicle. The housing can furthermore be installed on the vehicle on, or in the region of the underside of the vehicle. The housing can comprise at least one fastening means in order to install the housing on the vehicle. It is for example possible that the cover part and/or the base part have/has at least one opening, preferably a plurality of openings, for receiving a screw. This makes it possible to screw the housing to the vehicle.

In an installed state, in which the receiving device is installed on the vehicle, the cover part is arranged above the base part. Reference can be made hereinafter to the following coordinate system of the receiving device.

A vertical axis of the receiving device can be oriented perpendicularly to the upper side of the cover part and the underside of the base part. A longitudinal axis of the receiving device can be oriented parallel to the longitudinal direction of the housing. A transverse axis of the receiving device can be oriented parallel to the transverse axis of the housing. Here, the width of the housing along the lateral axis can be smaller than a length along the longitudinal axis. In the installed state, the vertical axis can be oriented parallel to the vertical axis or the yaw axis of the vehicle. Furthermore, the transverse axis of the receiving device can be oriented parallel to the transverse axis or pitch axis of the vehicle. The longitudinal axis of the receiving device may furthermore be oriented parallel to the longitudinal axis or roll axis of the vehicle. The axes can also be oriented perpendicularly to one another.

The housing furthermore has an internal volume for receiving at least one winding structure, in particular the secondary winding structure. In a closed state, in which the cover part and the base part are fastened to one another, the internal volume can be surrounded by the cover part and base part. The internal volume is thus delimited by the cover part and base part.

Besides receiving the winding structure, the internal volume can also be used to receive further components of the receiving device, in particular electrical and electronic components. These can be arranged for example on one, two, or more printed circuit boards, wherein the printed circuit boards likewise can be arranged in the internal volume. Furthermore, a magnetically conductive element, in particular a ferrite element, can be arranged in the internal volume. The receiving device can contain these further components, printed circuit boards and/or the magnetically conductive element.

The winding structure can comprise a first and at least one further sub-winding. The first and at least one further sub-winding are electrically connected.

The winding structure receives the electromagnetic field and provides an induced output voltage. In this case, the first sub-winding receives a first proportion of the electromagnetic field and the second sub-winding receives a further proportion of the electromagnetic field when the winding structure is exposed to the electromagnetic field. Each sub-winding can provide a pole of the electromagnetic field that is generated by the induced current.

A sub-winding can comprise one portion or a plurality of portions of a phase line of the winding structure. The winding structure can comprise one phase line or a plurality of phase lines for conducting an electrical current. A sub-winding can comprise a predetermined area. A sub-winding can have or form a coil, for example with a predetermined number of turns.

The at least one phase line can be formed in such a way that the course of the phase line is formed by an even or odd number of sub-windings arranged adjacently to one another. In this case a sub-winding denotes a conductor loop, preferably a closed conductor loop, which surrounds a predetermined area. The conductor loop can comprise or form one turn or a plurality of turns of the corresponding sub-winding.

Adjacently to one another can mean that central axes of the sub-windings, in particular axes of symmetry, are arranged at a distance from one another along a straight line, in particular at a predetermined distance. The straight line can be parallel to the longitudinal direction of the receiving device. This can mean that the phase line of the winding structure can extend along a direction of extent, wherein the predetermined number of sub-windings is provided along the direction of extent.

Adjacent sub-windings can be oriented oppositely. In this context, oppositely can mean that a flow of current in the first sub-winding is oriented in a clockwise direction, wherein the flow of current in the adjacent sub-winding is oriented in an anticlockwise direction. The clockwise direction can be defined with reference to parallel central axes which are oriented in the same direction. If a current is flowing in the sub-windings, adjacent sub-windings can generate a magnetic field of identical strength, but opposite orientation.

The winding structure preferably has the shape of a number eight. This can mean that the course of the at least one phase line is an eight-shaped course. In this case the phase line can have two sub-windings, which for example are circular or rectangular, and which are arranged adjacently to one another along the above-explained direction of extent.

The winding structure preferably comprises a first and a second sub-winding. In this case the winding structure can also be referred to as a double-D winding structure.

In accordance with the invention one of the housing parts has at least one rib and the other housing part has at least one groove for receiving the rib. A groove and a rib can be said to be corresponding if the groove is used to receive the rib. In a received state at least part of the rib extends into at least part of the groove.

It is also conceivable that a housing part has both at least one rib and at least one groove, in particular in different portions of the housing part. The other housing part can have a groove corresponding to the rib and/or a rib corresponding to the groove.

It is also possible, however, that one of the housing parts has at least one groove or at least one portion of the groove, wherein the other housing part has a corresponding rib or rib portion.

The cover part preferably has a groove and the base part preferably has the rib. Here, the rib can protrude upwardly from the surface, in particular an upper side of the base part. The depth of the groove is preferably greater than the height of the rib. The contour of the groove can be the same as the contour of the rib.

The rib and the groove can form a lip-and-groove connection in the fastened state. This lip-and-groove connection can be part of an interlocking and/or frictionally engaged connection. The groove or at least a portion thereof can thus be designed to receive the rib or at least a portion thereof, in particular in the closed state of the housing.

Furthermore, the rib and the groove are each arranged between the internal volume and an external volume. The external volume can refer to the volume outside the housing in the closed state of the housing. In particular, the rib and the groove can thus be arranged between an inner edge portion of the housing part which delimits the internal volume and an outer edge portion of the housing part which borders the external volume.

The rib and/or the groove preferably run/runs around at least part of the internal volume, preferably around the entire internal volume. In particular, the rib and/or the groove can have a closed course around the internal volume.

The fact that the rib and the groove run around at least part of the internal volume can mean for example that the groove and the rib are arranged between the internal volume and the external volume in a projection plane that can be oriented for example perpendicularly to the vertical axis of the receiving device.

The fact that the rib and the groove run around the entire internal volume can mean for example that the internal volume is surrounded completely by the groove and the rib in a projection plane that can be oriented for example perpendicularly to the vertical axis of the receiving device.

However, it is not mandatory for the rib and/or the groove to have a closed course around the internal volume. It is in particular conceivable that the course of the rib and/or the groove around the internal volume is not a closed course.

For example, one of the housing parts can have a plurality of ribs and the other housing part can have one groove or a plurality of grooves for receiving the ribs. If one of the housing parts has just one groove for receiving a plurality of ribs, this groove can thus have a closed course around the internal volume. If one of the housing parts has a plurality of grooves for receiving a plurality of ribs, these grooves therefore might not have, or form a closed course around the internal volume. The depth of a groove can change along the course of the groove. In other words, different portions of the groove can have different depths. The value of the depth, however, is different from zero.

Furthermore, the height of a rib may change along the course of the rib. In other words, different portions of the rib can have different heights. The value of the depth, however, is different from zero.

It is also possible that a housing part has or forms at least one groove and at least one rib. It is further possible that the rib changes its height along its course and transitions into a groove-free and rib-free region or into a groove. After the transition into the groove-free and rib-free region and/or into a groove, it can transition again along its course into a rib. It is also possible that a groove changes its depth along its course and transitions into a groove-free and rib-free region or into a rib. After the transition into the groove-free and rib-free region and/or into a rib, it can transition again along its course into a groove.

The receiving device furthermore comprises at least one sealing element, wherein at least one portion of the at least one rib and at least one portion of the sealing element are arranged in at least one portion of the at least one groove, in particular in the closed state of the housing. In the closed state both a part of the rib and at least a portion of the sealing element can thus be arranged in at least one portion of the groove. Furthermore, in particular in a further portion, only a portion of the sealing element, but no portion of a rib, can be arranged in the groove.

In particular, the receiving device can have precisely one sealing element, wherein at least one portion of the rib and at least one portion of the at least one sealing element is arranged in at least one portion of the at least one groove, in particular in the closed state of the housing. The sealing element can also be arranged completely in the groove, in particular in the closed state.

Here, the sealing element may likewise have a closed course. Furthermore, the sealing element can be formed integrally or in one part. The sealing element or at least a portion thereof can be arranged here in the groove or a portion thereof and, when the cover part is fastened to the base part, can be trapped in the groove by the cover part and base part. In particular, the sealing element can be pressed by the rib or a portion thereof in the fastened state into the groove.

In the closed state of the housing, which can also be referred to as the assembled state, the at least one portion of the rib and at least one portion of the sealing element can be arranged in at least one portion of the groove in such a way that the internal volume in this portion is sealed with respect to the external volume.

The sealing element and arrangement thereof thus enables the internal volume to be sealed to the best possible extent, in particular also completely, in particular in order to prevent an infiltration of moisture and particles of dirt.

The cover part can consist for example of aluminium or of an aluminium alloy. The base part can consist of plastic, in particular of glass-fibre-reinforced plastic. In the closed state, the cover part can be fastened to the base part in an interlocking and/or frictionally engaged manner.

This results advantageously in a reliable sealing of the internal volume and therefore reliable operation of the receiving device, in particular in a large temperature range.

In a further embodiment at least one of the housing parts has at least one fastening means for fastening the housing parts to one another, wherein the at least one fastening means is arranged outside the sealed internal volume. A fastening means here denotes an element or a component that is used to fasten the cover part to the base part, that is to say in particular to produce a mechanical connection.

The fact that at least one fastening means is arranged outside the sealed internal volume can mean that the fastening means is arranged in the common projection plane outside the course of the rib and the groove and the internal volume surrounded at least partially or completely by this course. The course can be in particular a course along the at least one rib. In the case of a housing part having a plurality of grooves, at least one groove and at least one rib, or having a plurality of ribs, the course can connect the grooves/ribs, which are different from one another, and can run around the internal volume.

The base part preferably has a through-opening as fastening means, and the cover part as fastening means preferably has a threaded portion as fastening means, which enable the parts to be screwed together. The through-opening, the threaded portion and also a screw required to produce a screwed connection can thus be arranged outside the sealed internal volume.

The risk of a leak on account of the fastening is hereby advantageously reduced or eliminated.

In a further embodiment at least one of the housing parts has a first membrane element. The cover part preferably has the first membrane element. In other words, the first membrane element can be part of the cover part. The membrane element can enable a pressure compensation between the internal volume and an external volume arranged outside the sealed internal volume. For example, the first membrane element can be arranged in a base portion of the cover part, wherein the first membrane element is arranged between the internal volume and the external volume. The first membrane element can be used for compensation between the pressure in the internal volume and the external pressure or in order to reduce the corresponding pressure difference.

In a preferred embodiment the first membrane element is vapour-permeable. Furthermore, the first membrane element can be semi-permeable.

The first membrane element can be designed in particular in such a way that vapour, in particular water vapour, can pass from the internal volume into the external volume, but not vice versa.

Due to temperature fluctuations of the temperature in the internal volume, it is possible that water molecules contained in the area of the internal volume condense. However, a condensation of this kind can compromise operation of the receiving device, in particular of the electrical and electronic components. As a result of the first membrane element, water molecules advantageously can pass from the internal volume into the external volume, however no water molecules, for example as a result of splashed water, can pass from the external volume into the internal volume.

Furthermore, the first membrane element can be arranged in a region of the housing, in particular the cover part, in which a large amount of thermal energy is transmitted during operation of the receiving device.

For example, it is possible that the first membrane element is arranged along the vertical axis of the receiving device in the installed state above power electronic components, for example above MOSFETs or above diodes of a rectifier circuit. Furthermore, the first membrane element can be arranged at an end of, or along a heat transfer means, which connects a thermal connection between the first membrane element or a region below the first membrane element and a region of high thermal energy input, for example a region in which the electrical or electronic components are arranged.

The receiving device can thus comprise at least one heat transfer means, for example a heat pipe, via which the first membrane element or the region below the first membrane element is thermally connected to a predetermined region in the internal volume, in particular a region intended for arrangement of a printed circuit board.

A sufficient vapour pressure drop between the internal volume and the external volume can hereby be generated, and in turn simplifies and accelerates the transport of water molecules out from the internal volume.

In a further embodiment at least one of the housing parts comprises at least one further membrane element. The cover part preferably also comprises the at least one further membrane element. The further membrane element can also be used for a compensation between the pressure in the internal volume and the external pressure or in order to reduce the corresponding pressure difference.

In a preferred embodiment the at least one further membrane element is elastic and impermeable to vapour.

Due to the significant temperature changes of the internal temperature, the pressure in the internal volume can also change significantly. This is caused in particular also by the generally mechanically rigid design of the cover part and base part, which do not allow large changes in volume of the internal volume caused by changes in pressure. So as not to generate an undesirable negative pressure in the internal volume, the further membrane element is elastic. The further membrane element can also be arranged between the internal volume and the external volume. Furthermore, the further membrane element can be arranged in a base part of the cover part. An inadmissible negative pressure may then form in the internal volume in particular if the transport of water molecules out from the internal volume through the first membrane element is not possible, for example if the first membrane element is covered by water. This can be the case for example if the vehicle, in particular the housing, drives through a puddle.

If the temperature of the housing, in particular of the internal volume, is higher than the external temperature, for example water of the puddle, and if the first membrane element is blocked, the cooling of the internal volume, on account of the temperature difference, may lead to generation of a negative pressure in the internal volume.

On account of the elasticity of the second membrane element, the volume of the internal volume can then change in such a way that a negative pressure in the internal volume is lower than a maximally permissible negative pressure.

In particular, the further membrane element can be formed elastically in such a way that it curves inwardly and thus reduces the internal volume in the event that the pressure in the internal volume drops below a predetermined pressure. Here, it can be assumed that a pressure from a predetermined pressure range, in particular atmospheric pressure, prevails in the external volume.

The further membrane element can alternatively be fastened to the housing so as to be movable relative thereto. In this case, the further membrane element can also be made of a mechanically stable material, for example plastic.

If the pressure in the internal volume drops below the pressure in the external volume, the further membrane element can thus curve inwardly and/or can move towards the internal volume. The internal volume is hereby reduced, which in turn limits the resultant negative pressure.

In a further embodiment an outer end of a membrane element, in particular an outer element of the first membrane element, is arranged in a channel on an outer side of the housing. The outer end of the membrane element can denote the end of the membrane element in contact with the external volume. In particular, the outer end can be arranged at the end of the channel. The channel can be inclined relative to the outer side in order to enable water to flow off from the membrane element.

The water transported outwardly from the internal volume through the membrane element can hereby advantageously be transported away from the membrane element easily, reliably and quickly, thus ensuring the functionality of said membrane element.

In a further embodiment the receiving device comprises at least one signal connection element. The signal connection element can be used to produce a connection for signal exchange between at least one component of the receiving device arranged in the internal volume and an external device, for example the communication system arranged in the vehicle. The signal connection element can be formed in particular as a plug-in connection element, for example as a plug or sleeve. The signal connection element extends from the internal volume into the external volume, wherein the signal connection means extends through the at least one sealing element. The sealing element in this case can have a through-opening, through which the signal connection means extends. The through-opening can be formed in particular as a slot. It is hereby made possible, advantageously, to produce a connection for signal exchange between the vehicle and the receiving device, wherein the risk of infiltration of dirt and moisture is minimised.

The signal connection element can have or form at least one groove for receiving the sealing element. In particular, the signal connection element can have a groove for receiving portions of the sealing element which surround the through-opening.

The height of a rib and/or the depth of the groove in a signal connection element receptacle region of the base part and the cover part can be different from a height or depth outside the signal connection element receptacle region. A signal connection element receptacle region can refer here to a region in which the signal connection element extends from the external volume into the internal volume. The sealing element can comprise the through-opening in the signal connection element receptacle region.

In the signal connection element receptacle region, the base part can have a groove-free and rib-free region into which the rib of the base part transitions along its course, that is to say a region with a height of zero above the surface. Here, a groove-free and rib-free region of this kind in the signal connection element receptacle region can be cut out from the base part, for example via indentations in the region of the upper side of the base part. It is also possible that the height of the rib decreases before and/or at a transition into the signal connection element receptacle region and increases at and/or after a transition from the signal connection element receptacle region.

In the signal connection element receptacle region, the cover part can have a groove-free and rib-free region or a rib into which the groove of the cover part transitions along its course. It is possible that the depth decreases before and/or at a transition into the signal connection element receptacle region and increases at and/or after a transition from the signal connection element receptacle region.

It is of course also conceivable that the receiving device comprises at least one signal connection element which extends from the internal volume into the external volume, wherein the signal connection element does not extend through a sealing element. For example, the signal connection means can extend from a portion of the internal volume into the external volume, wherein there is no sealing element, in particular also no groove and/or rib, arranged between this portion of the internal volume and the external volume.

In a further embodiment the at least one rib and the at least one groove, in particular corresponding ribs and grooves, each have at least one concave portion. The concave portion can be formed here along the course of the rib and the groove. In other words, the rib and the groove each have at least one portion curved towards the internal volume. As considered from the external volume, a recess or indentation can hereby be provided along the course of the rib and the groove. In particular, the fastening means explained previously or a part or portion thereof can be arranged in this recess, which can be the region surrounded by the concave portion. The installation space for the receiving device according to the invention is hereby reduced advantageously.

In a further embodiment the at least one sealing element has protrusions on an outer surface. These protrusions can be used to centre the sealing element in the groove. The protrusions can be arranged in particular in portions of the sealing element that are arranged in curved portions of the groove. The protrusions can thus be arranged in particular on curved portions of the sealing element. It is also possible that a spatial density of protrusions in curved portions of the sealing element is greater than in uncurved portions.

Furthermore, the protrusion can protrude laterally from the sealing element. This can mean that a protrusion protrudes towards a side wall of the groove when the sealing element is arranged in the groove. The sealing element can have protrusions which protrude on opposite sides laterally from the sealing element. Such protrusions can be arranged alternately on a first side and on a side opposite the first side along the course of the sealing element, preferably in uncurved portions of the sealing element in the inserted state. Alternatively, such protrusions can be arranged along the course of the sealing element in the same portion thereof, preferably in curved portions of the sealing element in the inserted state. A tilting of the sealing element when it is inserted into the groove (inserted state) is hereby advantageously prevented. Of course, such protrusions, which protrude on opposite sides of the sealing element laterally therefrom, can also be arranged along the entire course of the sealing element in alternation or in the same portions.

A simple centring of the sealing element, in particular in curved portions of the groove, is advantageously provided as a result. In a further embodiment the at least one sealing element is elastic in a temperature range from −40° C. to +120° C. A reliable sealing of the internal volume is advantageously hereby provided in a temperature range of internal temperatures of the housing that prevail during operation.

Further proposed is a method for producing a receiving device for a system for inductive power transmission, wherein a base part and a cover part are provided as housing parts of a housing of the receiving device. One of the housing parts furthermore has at least one rib, and the other housing part has at least one groove for receiving at least a portion of the rib. Furthermore, at least a portion of at least one sealing element is arranged in at least one portion of the at least one groove, wherein the cover part is connected to the base part in such a way that at least a portion of the rib is arranged in at least a portion of the groove and traps the sealing element arranged therein.

Furthermore, the at least one rib, the at least one groove, and the at least one sealing element are arranged between a (sealed) internal volume for receiving a winding structure and an external volume. In particular, the rib, the groove and a sealing element run around the sealed internal volume.

The method is suitable here for producing a receiving device according to one of the embodiments described in this disclosure. The method can thus comprise all steps necessary for this purpose.

What is furthermore described is a vehicle, wherein the vehicle comprises a receiving device according to one of the embodiments described in this invention. The receiving device can be fastened here to the vehicle, in particular in the region of the underside.

The receiving device can be connected to a communication system of the vehicle, for example a bus system, for data and/or signal exchange. Furthermore, the receiving device can be electrically connected to an electrical system of the vehicle, in particular a traction network. The receiving device can thus transmit provided electrical energy, which is provided in an induction-based manner, to the vehicle.

The invention will be explained in greater detail on the basis of an exemplary embodiment. The figures show:

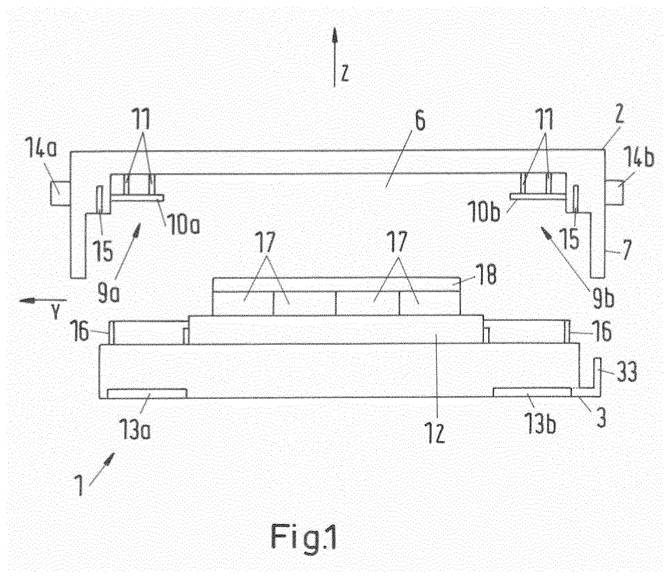

FIG. 1 a schematic cross-section through a receiving device according to the invention,

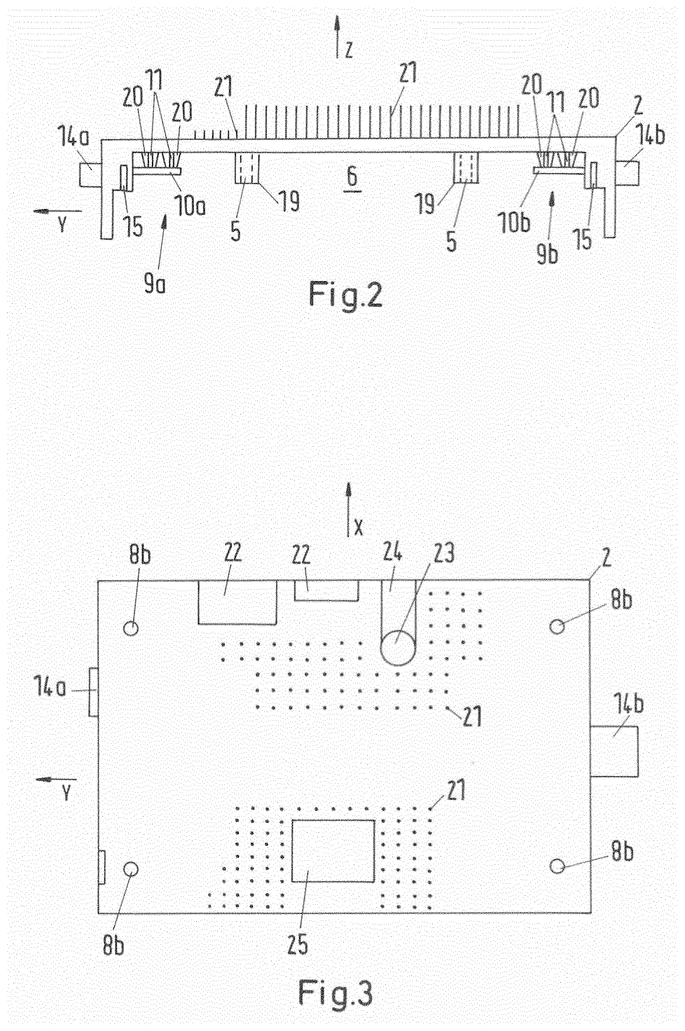

FIG. 2 a schematic cross-section through a cover part,

FIG. 3 a schematic plan view of a cover part,

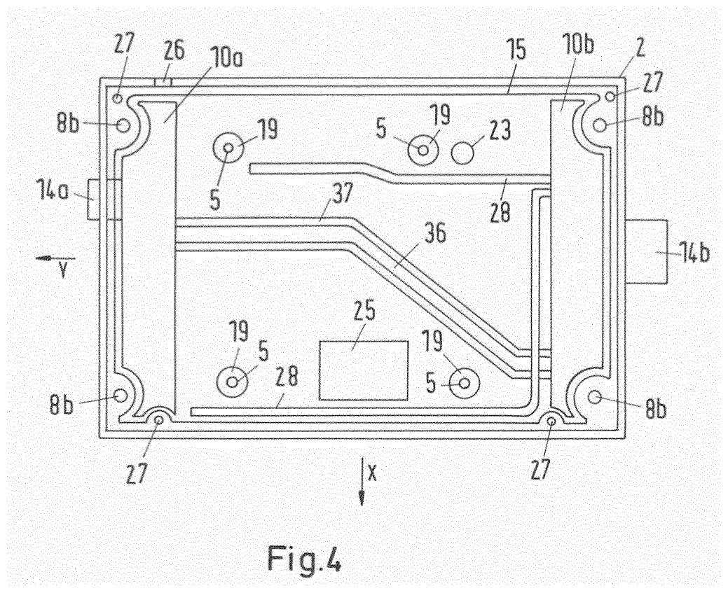

FIG. 4 a schematic view of a cover part from underneath,

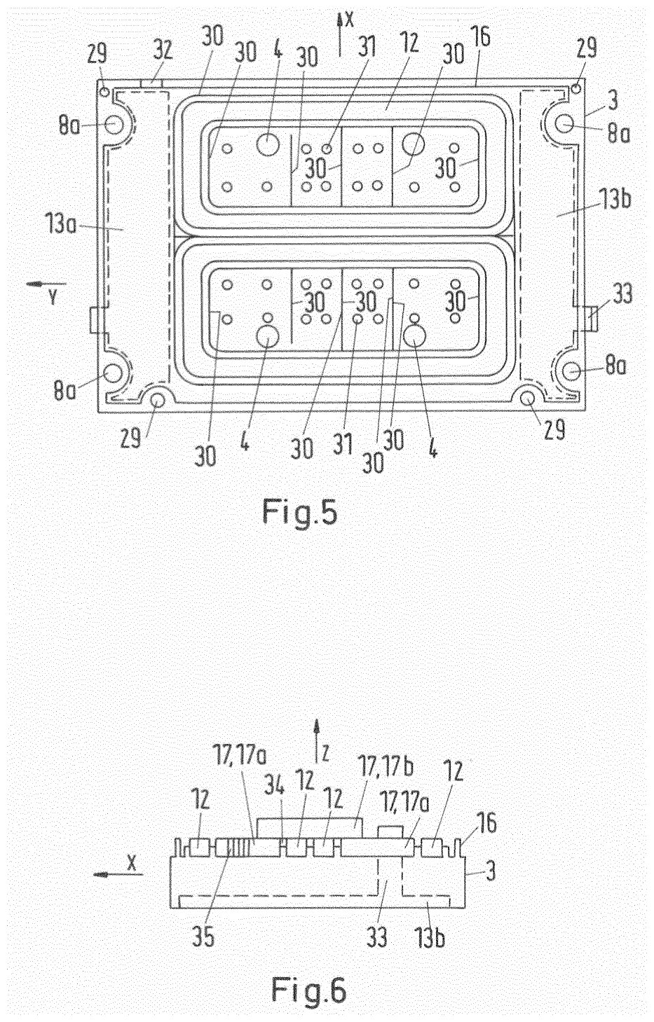

FIG. 5 a schematic plan view of a base part, and

FIG. 6 a schematic longitudinal section through a base part,

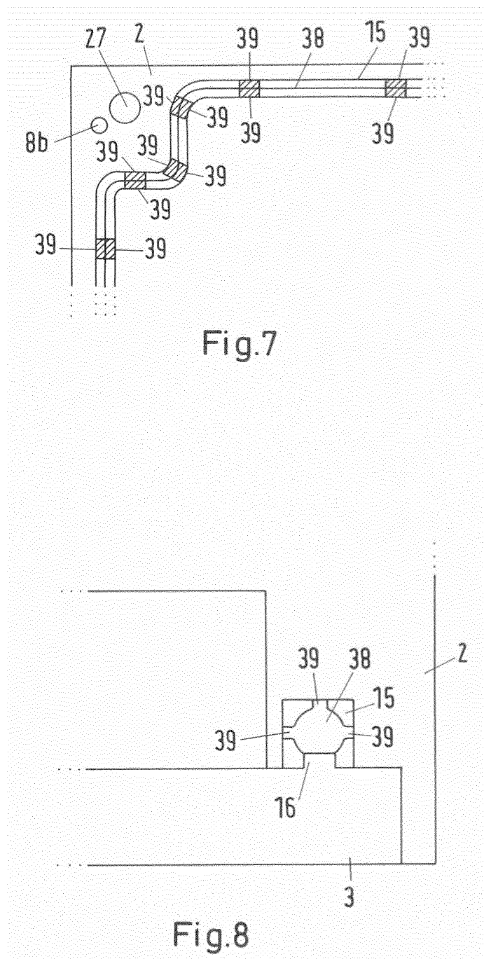

FIG. 7 a detailed view of a cover part from underneath,

FIG. 8 a detailed cross-section through a closed housing, and

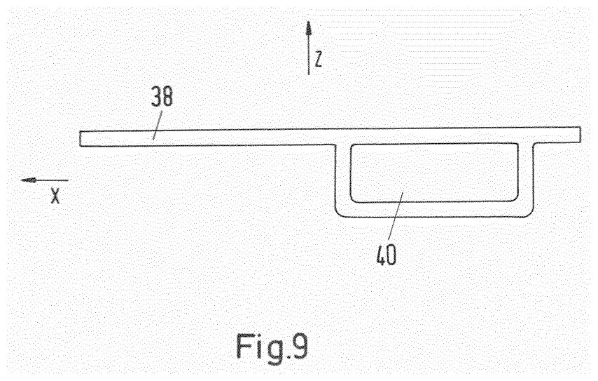

FIG. 9 a schematic side view of a sealing element,

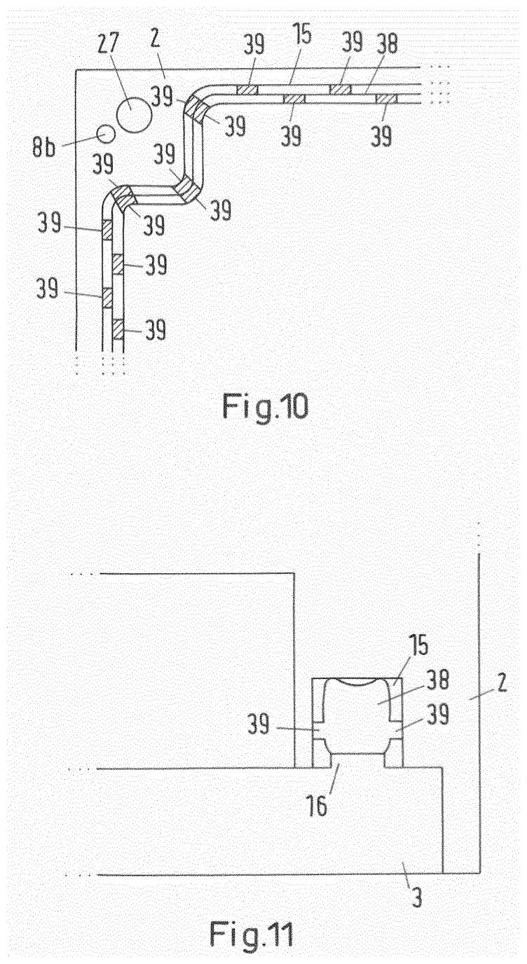

FIG. 10 a detailed view of a cover part from underneath,

FIG. 11 a detailed cross-section through a closed housing,

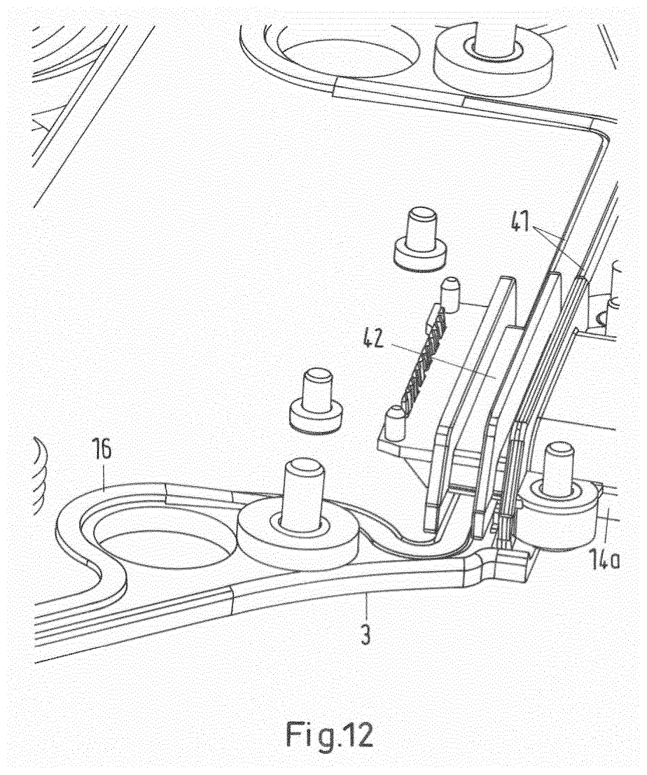

FIG. 12 a perspective view of an edge portion of a base part,

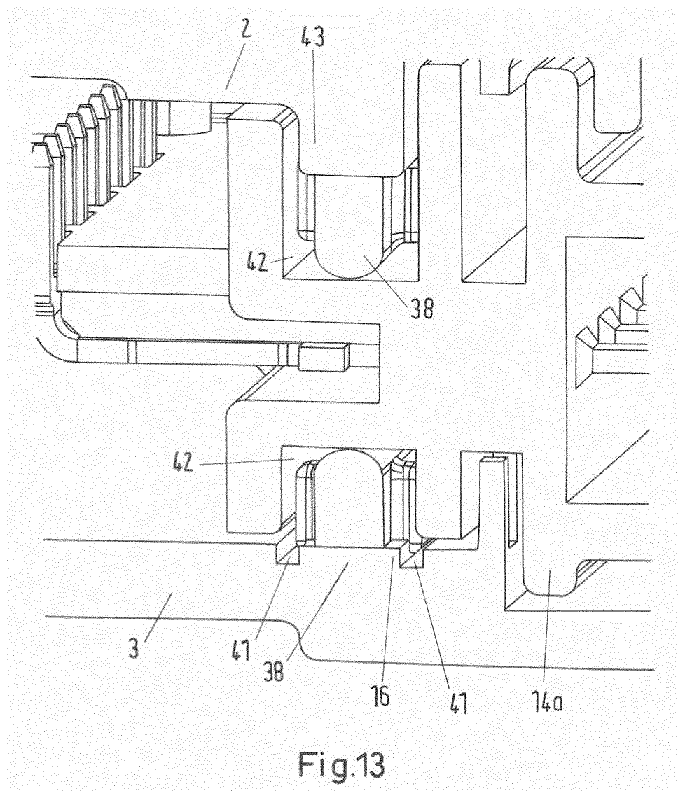

FIG. 13 a cross-section through a closed housing in a plug receptacle region.

Hereinafter, like reference signs denote elements having like or similar technical features.

FIG. 1 shows a schematic cross-section through a receiving device 1 of a system for inductive energy transmission. The receiving device 1 comprises a housing, wherein the housing comprises a cover part 2 and a base part 3. The cover part 2 consists of aluminium. The base part 3 consists of plastic, in particular glass-fibre-reinforced plastic.

The base part 3 can be fastened to the cover part 2, whereby a closed state of the housing or of the receiving device 1 is produced. In particular, the base part 3 can be screwed to the cover part 2. In order to provide a screwed connection of this kind, the base part 3 can have through-holes 4, 29 (see FIG. 5) and the cover part can have corresponding threaded portions 5, 27 (see FIG. 2). In the closed state the base part 3 is arranged fully in an internal volume 6 of the cover part 2. Side walls 7 of the cover part 2 in the closed state surround sides of the base part 3.

The receiving device can be fastened to a vehicle (not shown). In particular the receiving device 1 can be screwed to the vehicle, in particular to a front axle carrier of the vehicle. In order to provide a screwed connection of this kind, the base part 3 and the cover part 2 can have through-holes 8a, 8b that correspond to one another (see FIG. 5 and FIG. 3), wherein a screw can extend through the corresponding through-holes 8a, 8b in the cover part 2 and the base part 3 in the closed state. Furthermore, the screw can extend into a threaded portion of the vehicle.

It is also shown that the receiving device, in particular the cover part 2, has a first receptacle region 9a and a second receptacle region 9b. The receptacle regions 9a, 9b are spatial sub-regions of an internal volume of the housing and the closed state.

The following reference coordinate system can be used hereinafter. A vertical axis z can be oriented orthogonally to a flat surface of the cover part 2 or to a flat base surface of the base part 3. If the receiving device 1 is fastened to the vehicle, which can also be referred to as an installed state, the vertical axis z can thus be oriented parallel to a yaw axis of the vehicle. Furthermore, a vertical direction can be oriented parallel to the main direction of the inductive power transmission. Furthermore, a lateral axis y is shown, wherein the lateral axis y is oriented perpendicularly to the vertical axis z. In the installed state the lateral axis y can be oriented parallel to a pitch axis of the vehicle. FIG. 3 shows a longitudinal axis x. The longitudinal axis is oriented orthogonally to the vertical axis and lateral axis z, y. In the installed state the longitudinal axis x can be oriented parallel to a roll axis of the vehicle. Furthermore, a vertical direction, a lateral direction, and a longitudinal direction are shown by direction arrows.

In the fastened state of the receiving device 1, the cover part 2 is installed on the base part 3.

It is also shown that the first receptacle region 9a is arranged on a first lateral edge region of the receiving device 1, in particular of the cover part 2. The second receptacle region 9b is arranged in a second lateral edge region. The edge regions are arranged here on opposite ends of the receiving device 1 with respect to the lateral axis y.

A receptacle region 9a, 9b can be formed for example by an indentation in the receiving device, in particular in the cover part 2. Alternatively or cumulatively, a receptacle region 9a, 9b can be defined by fastening means for fastening a printed circuit board 10a, 10b to the receiving device 1, in particular for fastening to the cover part 2.

It is also shown that the receiving device 1 comprises a first printed circuit board 10a and a second printed circuit board 10b. The first printed circuit board 10a is arranged in the first receptacle region 9a. Furthermore, the first printed circuit board 10a is fastened to the cover part 2. Furthermore, the second printed circuit board 10b is arranged in the second receptacle region 9b. Furthermore, the second printed circuit board 10b is fastened to the cover part 2.

In particular, the printed circuit boards 10a, 10b can be screwed to the cover part 2. In order to provide a screwed connection of this kind, screws 11 can extend through through-holes in the printed circuit boards 10a, 10b (not shown) into threaded portions of the cover part 2. The mechanical connection between the printed circuit boards 10a, 10b and the cover part 2 can also provide an electrical connection between the printed circuit boards 10a, 10b and the cover part 2.

It is possible that the cover part 2 is electrically connected to a reference potential, for example a ground potential, of the vehicle. In this case the electrical connection of the printed circuit boards 10a, 10b to the cover part 2 can also provide an electrical connection of the printed circuit boards 10a, 10b to the reference potential. The electrical connection between the cover part 2 and the reference potential of the vehicle can be provided here by the mechanical connection between the receiving device in the vehicle, in particular by the screws for fastening the receiving device 1 to the vehicle.

In the closed state of the housing or in the installed state of the receiving device, the receptacle regions 9a, 9b are arranged laterally or next to a winding structure 12 (see FIG. 5) for receiving the electromagnetic alternating field for power transmission with respect to the lateral direction. The winding structure 12 can be arranged in a central portion of the internal volume of the housing in the closed state.

It is also shown that the receiving device comprises a first magnetic shield element 13a and a second magnetic shield element 13b. A magnetic shield element here refers to an element for shielding the magnetic field. The magnetic shield elements 13a, 13b can be formed as aluminium plates. Furthermore, the magnetic shield elements 13a, 13b can be fastened to the base part 3. In particular, the magnetic shield elements 13a, 13b can be arranged in indentations on a bottom side of the base part. Furthermore, the underside of the magnetic shield elements 13a, 13b can be arranged flush with the underside of the base part 3. The first magnetic shield element 13a fully covers the first receptacle region 9a from underneath. In other words, the first magnetic shield element 13a is arranged beneath the first receptacle region 9a with respect to the vertical direction. Furthermore, the first magnetic shield element 13a is arranged in such a way that the first receptacle region 9a, in particular the first printed circuit board 10a, which is arranged in the first receptacle region 9a, is shielded fully from beneath from a magnetic field. As a result, an amount of magnetic field lines which extend through the receptacle regions 9a, 9b when an electromagnetic alternating field for power transmission is provided is thus minimised or even reduced to zero. Magnetic shield elements 13a, 13b are arranged in such a way that an interaction of electrical and/or electronic elements, in particular elements of the printed circuit boards 10a, 10b, with the electromagnetic field for power transmission is minimised.

The first printed circuit board 10a can also be referred to as a low-voltage printed circuit board. This can mean that electrical and electronic components of the first printed circuit board 10a can be supplied with a maximum voltage of 12 V or 42 V or can provide such a voltage. The second printed circuit board 10b can also be referred to as a high-voltage printed circuit board. This can mean that electrical and electronic components of the second printed circuit board 10b can be supplied with a maximum voltage of up to 1200 V or can provide such voltage.

Components of the first printed circuit board 10a can thus provide control means for controlling operation of the receiving device 1 and communication means for providing communication with the vehicle and/or a primary unit. Components of the second printed circuit board 10b can thus provide a desired direct voltage of the receiving device 1 from the alternating voltage which is induced in the winding structure 12 by the electromagnetic field for power transmission.

A first plug 14a is also shown, by means of which a signal and a data connection to components of the first printed circuit board 10a can be produced. The first plug 14a can be formed for example as a CAN plug. At least part of the first plug 14a is arranged here on an outer surface of a side wall of the cover part 2. A second plug 14b, which can also be referred to as a power plug or direct voltage interface, is also shown. A connection for power transmission and, as applicable, for signal transmission between components of the second printed circuit board 10b and the vehicle can be produced by the second plug 14b. The second plug 14b can also be arranged on an outer surface of a side wall of the cover part. The second plug 14b can be a plug with cable gland in order to ensure the seal of the internal volume of the housing and the closed state.

A groove 15 of a lip-and-groove connection is also shown. The groove 15 is arranged here in an edge region of the cover part 2. In particular, the groove 15 is a circumferential groove. The groove 15 is used to receive a sealing element, in particular a circumferential sealing element (not shown).

The base part 3 has a corresponding lip of the lip-and-groove connection formed as a rib 16. The rib 16 is arranged in an edge region of the base part 3 and on an upper side of the base part 3. In particular, the lip 16 is provided by a rib which protrudes from the upper side of the base part 3.

In the closed state of the housing, the lip 16 extends into the groove 15 and clamps the sealing element in the groove 15.

In this way, a robust and reliable seal of the internal volume of the housing, in which the printed circuit boards 10a, 10b and the winding structure 12 are arranged, can be produced. The lip 16 can also be formed as a circumferential lip.

Ferrite bars 17, which are part of a ferrite arrangement and provide magnetically conductive elements, are also shown. Here, it is shown that the ferrite bars 17 are arranged in and on the winding structure 12, in particular above a central portion of the winding structure 12. The ferrite bars 17 and the winding structure 12 can be fastened to the base part 3. In particular, the winding structure 12 and the ferrite bars 17 can be cast with the base part 3. The ferrite bars 17 can be arranged in such a way that a desired course of field lines of the magnetic field is produced.

A thermally conductive pad 18, which forms a heat-conductive element, is also shown. The thermally conductive pad 18 is arranged on the ferrite bars 17. The thermally conductive pad 18 can have a high thermal conductivity. In the closed state of the housing the thermally conductive pad can contact an inner portion of a housing wall and the ferrite bars 17 and can thus produce a thermal connection between the ferrite elements 17 and the cover part 2.

Furthermore, the thermally conductive pad 18 can provide an adhesive element. For example, it is possible that the thermally conductive pad is formed as a double-sided adhesive element or one-sided adhesive element. The thermally conductive pad 18 can thus be used to secure a ribbon cable 36 in a receptacle groove 37 of the cover part 2 (see FIG. 4). Alternatively to the ribbon cable 36, a flexible printed circuit board can also be used in the receptacle groove 37.

In other words, the receiving device 1 can comprise at least one heat-conductive element, wherein the heat-conductive element produces a thermal connection between the cover part 2 and the winding structure 12 or a ferrite arrangement in a closed state of the housing. In particular, the heat-conductive element can mechanically contact the cover part 2 and the winding structure 12 or the ferrite arrangement.

FIG. 2 shows a schematic cross-section through the cover part 2. The printed circuit boards 10a, 10b, which are fastened to the cover part 2 by screws 11, are shown. The groove 15 of the lip-and-groove connection is also shown. Cylindrical protrusions 19 on the underside of the cover part 2, which comprise a threaded portion for receiving the screws 11 for fastening the base part 3 to the cover part 2 are also shown.

Conical protrusions 20 of the cover part 2, in particular on the underside of the cover part 2, which extend into the internal volume 6 of the cover part 2 and provide the thread for the screws 11 for fastening the printed circuit boards 10a, 10b to the cover part 2 are also shown. These conical protrusions 20 are arranged in the receptacle regions 9a, 9b and extend through through-holes into the printed circuit boards 10a, 10b (not shown). This advantageously allows the printed circuit boards 10a, 10b to be aligned in the corresponding receptacle region 9a, 9b. Cooling bars 21, which are arranged on an upper side of the cover part 2, are also shown. The cooling bars 21 can have different lengths. The length can be selected here in accordance with the installation space conditions. Alternatively or cumulatively to the cooling bars 21, it is also possible for cooling ribs to be arranged on the upper side of the cover part 2.

The cooling bars 21 can be arranged in a central portion of the cover part 2. In particular, the cooling bars 21 can be arranged outside volumes that are arranged above the receptacle regions 9a, 9b or above the printed circuit boards 10a, 10b. The cooling bars 21 allow a transmission of thermal energy from the cover part 2 into a surrounding environment by convection.

FIG. 3 shows a schematic plan view of a cover part 2. The through-holes 8b for receiving screws in order to fasten the receiving device 1 to the vehicle are shown. Cooling bars 21, which protrude from an upper side of the cover part 2, are also shown. Indentations 22 in the upper side of the cover part 2 are also shown. These indentations 22 reduce the internal volume of the housing in the closed state of the housing. In particular, the indentations 22 can reduce the amount of air in the internal volume of the receiving device 1. This in turn can reduce a change in pressure of the pressure in the internal volume as a result of changes in temperature. It is possible that temperatures in the receiving device 1 vary between −40° C. and 120° C. These changes in temperature can be dependent on a change in temperature of the external temperature and on thermal energy that is generated by electrical and electronic components in the internal volume, in particular on components of the second printed circuit board 10b. The changes in temperature can result in a change in pressure of the pressure in the internal volume. A reduction of the internal volume therefore advantageously allows a reduction of the level of the change in pressure.

A first membrane element 23 is also shown. The first membrane element 23 is formed as a semi-permeable, vapour-permeable element. In particular, the vapour-permeable membrane element 23 allows vapour to escape from the internal volume of the receiving device through the membrane element 23 in a closed state of the housing. The first membrane element 23 extends through the cover part 2. The membrane element 23 is arranged on the upper side of the cover part 2 in an inclined channel 24 for water drainage.

A second membrane element 25 is also shown. The second membrane element is provided by a flexible, non-permeable, in particular non-vapour-permeable material, for example by rubber. The second membrane element advantageously makes possible a change in the internal volume of the receiving device 1 in the closed state of the housing. On account of the above-described changes in temperature, the pressure in the internal volume can exceed a maximally permissible pressure. The second membrane element 25 can be formed in particular in such a way that it deforms under a pressure that is higher than a predetermined pressure.

In particular if the first membrane element 23 does not allow diffusion of vapour from the internal volume of the housing into a surrounding environment, the second membrane element 25 allows the pressure in the internal volume to lie within certain limits as a result of a deformation. For example, vapour diffusion might then not be possible if the first membrane element 23 is covered by water, for example if the vehicle drives through a deep puddle.

FIG. 4 shows a schematic view of a cover part 2 from beneath. The printed circuit boards 10a, 10b are shown. An edge region of the cover part 2, in particular an edge region that encloses the first printed circuit board 10a, has an indentation 26 for receiving a tongue 32 (see FIG. 5) of the first magnetic shield element 13a. The tongue 32 connects the first magnetic shield element 13a to the cover part 2 and thus produces an electrical connection between the first shield element 13a and thus to the reference potential of the vehicle.

Cylindrical protrusions 19 with the threaded portion 5 are also shown. The first and the second membrane element 23, 25 are also shown. Threaded portions 27 in the cover part 2 which allow the base part 3 to be screwed to the cover part 2 are also shown. The groove 15 of the lip-and-groove connection surrounding the printed circuit boards 10a, 10b and a central portion of the cover part 2 is also shown.

A receptacle groove 37 for receiving a ribbon cable 36 is also shown. The ribbon cable 36 produces a data and signal connection between components of the first printed circuit board 10a and components of the second printed circuit board 10b. The ribbon cable 36 can be secured in the receptacle groove 37 by adhesive elements. Here, it is possible that the adhesive elements are provided by thermally conductive pads 18 (see FIG. 1).

Heat conduction pipes 28 are also shown, wherein the heat conduction pipes 28 extend from the second printed circuit board 10b into the central region of the cover part 2. In particular, the heat conduction pipes 28 extend from the second printed circuit board 10b into a region beneath the cooling bars 21 (see FIG. 2 and FIG. 3). The heat conduction pipes 28 enable a transmission of thermal energy from the second printed circuit board 10b, in particular from heat-generating components of the second printed circuit board 10b, for example power electronic components, into the central region. This in turn enables the distribution of thermal energy within the receiving device 1, which advantageously reduces the thermal loading of the second printed circuit board 10b and components thereof.

The heat conduction pipes can be arranged in receptacle grooves of the cover part 2, in particular in receptacle grooves in inner wall portions of the cover part 2.

FIG. 5 shows a schematic plan view of a base part 3. The through-holes 4 and further through-hole 29 for providing a screw connection between the base part 3 and the cover part 2 are shown. The through-holes 8a for providing a screw connection of the receiving device 1 to the vehicle are also shown. The lip 16 (see also FIG. 6) of the lip-and-groove connection is also shown. Dashed lines show the magnetic shield elements 13a, 13b.

Ribs 30, which protrude from the upper side of the base part 3, are also shown. These ribs 30 comprise a receptacle region for the winding structure 12 and for the ferrite bars 17 (see FIG. 1) and therefore define the receptacle region. The protruding ribs also increase the mechanical stability of the base part 3.

The protruding ribs 30 are arranged in a central region of the base part 3, in particular in a region between the volumes above the magnetic shield elements 13a, 13b.

Cylindrical protrusions 31 are also shown on the upper side of the base part 3. These protrusions 31 are arranged in the receptacle regions for the ferrite bars 17. For the sake of clarity, only two cylindrical protrusions 31 have been provided with a reference sign. These cylindrical protrusions 31 serve as spacer elements in order to provide a desired spacing between the upper side of the base part 3 and the underside of a ferrite bar 17.

A tongue 32 is also shown, which electrically connects the first magnetic shield element 13a to the cover part 2. A tongue 33 which connects the second magnetic shield element 13 to the cover part 2 is also shown.

FIG. 6 shows a schematic longitudinal section through a base part 3. The groove of the lip-and-groove connection between the base part 3 and the cover part 2 is shown. The second magnetic shield element 13b with the tongue 33 is also shown.

The winding structure 12 is also shown, wherein the winding structure 12 is provided by a double-D winding structure as explained previously. Ferrite bars 17 are also shown, wherein lower ferrite bars 17a are arranged beneath an upper ferrite bar 17b. The arrangement of the ferrite bars 17a, 17b provides a recess 34 for receiving a central portion of the winding structure 12.

An antenna element 35, which is provided by an antenna winding structure, which is wound around one of the lower ferrite bars 17a, is also shown. The antenna element 35 can be used to produce a wireless signal connection between components of the first printed circuit board 10a and a primary unit.

FIG. 7 shows a detailed view from beneath of a cover part 2 with a threaded portion 27 and a through-opening 8b. A groove 15 of a lip-and-groove connection with a sealing element 38 arranged therein is also shown. Along its course, the sealing element has protrusions 39 on an outer surface. The protrusions 39 protrude in the direction of the side walls of the groove 15 from a central portion of the sealing element 38. Here it is shown that a protrusion 39 that protrudes in the direction of a first side wall of the groove 15 and a protrusion 39 that protrudes in the direction of a second side wall of the groove 15 opposite the first side wall are arranged along the course of the central portion of the sealing element 38 in the same sub-portion of the sealing element 38. The sealing element 38 thus has sub-portions along the course of the central portion of the sealing element 38, in which sub-portions protrusions 39 protrude towards both side walls of the groove 15.

These protrusions 39 are used to centre the sealing element 38 in the groove 15. It is also shown that a spatial density of protrusions 39 in a curved portion of the sealing element 38 is greater than a spatial density in a straight portion of the sealing element 38.

FIG. 8 shows a detailed cross-section through a closed housing outside a plug receptacle region. The cover part 2 and the base part 3 are shown. The cover part 2 has a groove 15 of a lip-and-groove connection, which groove is also used to receive a sealing element 38 with protrusions 39 on the outer side. The rib that forms the lip 16 of the lip-and-groove connection is also shown, wherein the rib is formed by the base part 3.

FIG. 9 shows a schematic side view of a sealing element 38. It is shown that the sealing element 38 forms a through-opening 40. For example, the first plug 14a (see FIG. 1, for example) can extend through this through-opening, so as to be guided out from the sealed internal volume on the outer side.

FIG. 10 shows a detailed view from beneath of a cover part 2 with a threaded portion 27 and a through-opening 8b in a further embodiment. A groove 15 of a lip-and-groove connection with a sealing element 38 arranged therein is also shown. Along its course, the sealing element has protrusions 39 on an outer surface. In contrast to the embodiment shown in FIG. 7, only curved portions, that is to say non-straight portions, of the course of the central portion of the sealing element 38 have sub-portions in which protrusions 39 protrude towards both side walls of the groove 15. In uncurved, that is to say straight portions of the course of the central portion, there are arranged protrusions 39, which protrude towards the first side wall of the groove 15 along the course of the sealing element 38 offset in relation to protrusions 39 protruding towards the second side wall of the groove 15. In particular, a protrusion 39 in such an uncurved portion in a first sub-region can protrude towards a first side wall of the groove 15, wherein no protrusion 39 in this first sub-portion protrudes towards the second side wall. Furthermore, in a further sub-portion along the course, a protrusion 39 can protrude towards the second side wall, wherein no protrusion 39 towards the first side wall protrudes in this further sub-portion. In other words, the protrusions 39 protruding towards different side walls of the groove 15 are arranged alternately to one another in uncurved portions of the central portion of the sealing element 38 along its course. Such an embodiment advantageously hinders a tilting of the sealing element 38 in the groove 15.

FIG. 11 shows a detailed cross-section through a closed housing outside a plug receptacle region. The cover part 2 and the base part 3 are shown. The cover part 2 has a groove 15 of a lip-and-groove connection, which is also used to receive a sealing element 38 having protrusions 39 on the outer side. In contrast to the embodiment shown in FIG. 9, the sealing element 38 has only protrusions that protrude in the direction of side walls of the groove 15. On an underside of the sealing element 38, this has a double lip portion or forms same, wherein, as a result of the double lip portion, two contact portions of the sealing element 38 with a base surface of the groove 15 are provided. The underside of the sealing element 38 can denote here the side that in the assembled state contacts the base surface of the groove 15. On an upper side of the sealing element 38, this has a single lip portion or forms same, wherein only one contact portion with the base part 3 is provided by the single lip portion. The upper side of the sealing element 38 can denote the side that contacts the base part 3 in the assembled state.

FIG. 12 shows a perspective view of an edge portion of a base part 3. In the edge portion, the base part 3 has a rib 16, wherein the rib 16, along its course, has a height that changes above an upper side of the base part 3. Here, it is shown that the height changes with a ramp-like profile. In particular, the rib 16 transitions along its course into a groove-free and rib-free region, wherein this is formed by being cut out in the region of the upper side of the base part 3 and has a height above the upper side of zero. This region transitions again along its course into a rib 16. The cut-outs are formed here by indentations 41 in the region of the upper side. This groove-free and rib-free region with a height of zero above the upper side can be arranged in particular in a plug receptacle region of the base part 3.

A first plug 14a is also shown. The first plug 14a here forms grooves 42 for receiving a sealing element 38 not shown in FIG. 12. The first plug 14a can extend in particular through a through-opening 40 of the sealing element 38 shown in FIG. 9, wherein the portions of the sealing element 38 which surround the through-opening are arranged in the grooves 42.

In the portions in which the rib 16 does not have the maximum height above the upper side of the base part 3, the sealing element 38 cannot be pressed or cannot be pressed fully by the rib 16 into a corresponding groove 15 in the cover part 2. It is thus possible that in such portions the sealing element 38 protrudes beyond upper edges of the groove 15 or protrudes out from the groove 15.

FIG. 13 shows a cross-section through a closed housing in a plug receptacle region. A base part 3 and a cover part 2 are shown. A first plug 14a, which has or forms the grooves 42 for receiving a sealing element 38, is also shown. Here, the first plug 14a extends through a through-opening 40 in the sealing element 38 shown in FIG. 9, wherein the portions of the sealing element 38 which surround the through-opening 40 are arranged in the grooves 42. A groove-free and rib-free region of the base part is shown, into which the rib 16 transitions along its course and transitions back along its course into a rib 16. This region has cut-outs formed by indentations 41 in the region of the upper side of the base part 3.

It is also shown that the cover part forms a rib 43, which in the closed state of the housing is received by a groove 42 of the first plug 14a. The cover part 2, in addition to the groove 15 shown for example in FIG. 8, can thus form the rib 43. It is possible that the cover part 2 forms the rib 43 only in the plug receptacle region. In the other regions, the cover part 2 can form the groove 15. In particular, the groove 15 can transition along its course into the rib 43. The rib 43 can also transition along its course into a groove 15.

The embodiment shown in FIG. 12 and FIG. 13 makes it possible to reliably receive the first plug 14a with minimal overall height of the housing in the closed state. In particular, it is ensured that the first plug 14a can extend into the housing, wherein the internal volume, in the plug receptacle region, is also reliably sealed with respect to the external volume.

### LIST OF REFERENCE SIGNS

1 receiving device

2 cover part

3 base part

4 through-opening

5 threaded portion

6 internal volume

7 side walls

8a, 8b through-opening

9a, 9b receptacle regions

10a, 10b printed circuit board

11 screw

12 winding structure

13a, 13b magnetic shield element

14a, 14b plug

15 groove

16 rib

17 ferrite bar

17a, 17b ferrite bar

18 thermally conductive pad

19 cylindrical protrusion

20 conical protrusion

21 cooling bar

22 recess

23 first membrane element

24 channel

25 second membrane element

26 groove

27 threaded portion

28 heat conduction pipe

29 through-opening

30 rib

31 cylindrical protrusion

32 tongue

33 tongue

34 recess

35 antenna element

36 ribbon cable

37 receptacle groove

38 sealing element

39 protrusion

40 opening

41 indentation

42 groove

43 rib

1. A receiving device for a system for inductive power transmission, the receiving device comprising:
a housing, wherein the housing comprises a cover part and a base part as housing parts, wherein the housing has an internal volume for receiving at least one winding structure,
wherein
one of the housing parts has at least one rib and the other housing part has at least one groove for receiving the at least one rib,
wherein the at least one rib and the at least one groove are arranged between the internal volume and an external volume,
wherein the receiving device comprises at least one sealing element,
wherein at least a portion of the at least one rib and at least a portion of the at least one sealing element are arranged in at least a portion of the at least one groove,
wherein
the receiving device comprises at least one signal connection means,
wherein the signal connection means extends from the internal volume into an external volume, and
wherein the signal connection means extends through the at least one sealing element.

2. The receiving device according to claim 1, wherein at least one of the housing parts has at least one fastening means for fastening the housing parts to one another, wherein the at least one fastening means is arranged outside the sealed internal volume.

3. The receiving device according to claim 1, wherein at least one of the housing parts has a first membrane element.

4. The receiving device according to claim 3, wherein the first membrane element is vapour-permeable.

5. The receiving device according to claim 3, wherein at least one of the housing parts comprises at least one further membrane element.

6. The receiving device according to claim 5, wherein the further membrane element is elastic and vapour-impermeable.

7. The receiving device according to claim 5, wherein an outer end of at least one of a first membrane element and the further membrane element is arranged in a channel on an outer side of the housing.

8. The receiving device according to claim 1, wherein the at least one rib and the at least one groove each have at least one concave portion.

9. The receiving device according to claim 1, wherein the at least one sealing element has protrusions on an outer surface.

10. The receiving device according to claim 1, wherein the at least one sealing element is elastic in a temperature range from −40° C. +120° C.

11. A method for producing a receiving device for a system for inductive power transmission, the method comprising:
providing a base part and a cover part as housing parts of a housing of the receiving device, wherein one of the housing parts has at least one rib and the other housing part has at least one groove for receiving the at least one rib,
arranging at least a portion of a sealing element in at least a portion of the groove, and
connecting the cover part to the base part in such a way that at least a portion of the at least one rib is arranged in at least a portion of the at least one groove and traps the sealing element arranged therein,
wherein the at least one rib, the at least one groove and the at least one sealing element are arranged between an internal volume for receiving a winding structure and an external volume,
wherein the receiving device comprises at least one signal connection means,
wherein the signal connection means extends from the internal volume into an external volume, and
wherein the signal connection means extends through the at least one sealing element.
